(19) United States
(12) Patent Application Publication
(10) Pub. No.: US 2011/0176170 A1
(43) Pub. Date: Jul. 21, 2011

(54) PRINTING APPARATUS, PRINTING SYSTEM, AND CONTROL METHOD

(75) Inventor: Hideki Sugiyama, Kawasaki-shi (JP)

(73) Assignee: CANON KABUSHIKI KAISHA, Tokyo (JP)

(21) Appl. No.: 13/006,021

(22) Filed: Jan. 13, 2011

(30) Foreign Application Priority Data
Jan. 15, 2010 (JP) 2010-006742

(51) Int. Cl. G06F 3/12

(52) U.S. Cl. 358/1.15

(57) ABSTRACT

A printing apparatus includes a storage unit configured to store a plurality of setup programs for respective printer drivers registered by a management apparatus, an update unit configured to set configuration information of the printing apparatus for installing the printer drivers with respect to the stored setup programs and to update the setup programs, and a provision unit configured to transmit information of the stored setup programs to an information processing apparatus according to a request from the information processing apparatus and to provide a setup program selected by the information processing apparatus.

### BACKGROUND OF THE INVENTION

1. Field of the Invention

The present invention relates to a printing apparatus, a printing system, a control method, and a storage medium.

2. Description of the Related Art

When a printing apparatus prints, for example, a document according to an instruction sent from a personal computer (PC), a printer driver that controls the printing apparatus and generates print data is to be installed in the PC. Generally, a printer driver is developed for each operating system (OS) of PCs or each type of printing apparatus used for printing, and is provided via a storage medium such as a compact disc read-only memory (CD-ROM) supplied with the printing apparatus.

Further, an administrator of a printing apparatus generally obtains the latest printer driver by downloading the printer driver from a website of the manufacturer of the printing apparatus via a public network. Furthermore, the obtained printer driver is stored in a shared storage device on the network. When the availability of the printer driver is announced to the general users, the general users install the printer driver in the PC.

If a plurality of printing apparatuses are introduced to an office, it is natural that each user uses a different printing apparatus. Thus, installing the printer driver and making the settings for the connection without an error has been a troublesome work for both the administrator and the general users.

As a method for installing a printer driver in a PC, Japanese Patent Application Laid-Open No. 2001-051810 discusses a system where a latest printer driver is stored in a storage device connected to a printing apparatus. When the printing apparatus receives a print request from a PC, the latest printer driver is transmitted to the PC.

Some of the recent printing apparatuses can deal with a plurality of page description languages (PDLs). Further, there are needs for a customized printer driver (e.g., having two-sided printing as a default setting) for each user.

However, the technique discussed in Japanese Patent Application Laid-Open No. 2001-051810 is not intended for storing and uploading a plurality of printer drivers in the storage device connected to the printing apparatus. Thus, the user is unable to select a printer driver (with a desired PDL or of a desired version, or a customized printer driver) from the printing apparatus and to install the selected printer driver. For this reason, although there are needs for each user to freely select a printer driver from a printing apparatus and installing the selected printer driver, the idea has been impracticable.

### SUMMARY OF THE INVENTION

According to an aspect of the present invention, a printing apparatus includes a storage unit configured to store a plurality of setup programs for respective printer drivers registered by a management apparatus, an update unit configured to set configuration information of the printing apparatus for installing the printer drivers with respect to the stored setup programs and to update the setup programs, and a provision unit configured to transmit information of the stored setup programs to an information processing apparatus according to a request from the information processing apparatus and to provide a setup program selected by the information processing apparatus to the information processing apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a printing system according to an exemplary embodiment of the present invention.

FIG. 2 is a block diagram illustrating an inner configuration of an information processing apparatus and a printing apparatus.

FIG. 3 illustrates an example of a device selection screen.

FIG. 4 illustrates an example of an upload condition setting screen.

FIG. 5 illustrates an example of a driver download screen.

FIG. 6 illustrates a configuration of main modules of the printing system illustrated in FIG. 1.

FIG. 7 is a flowchart illustrating an example of device selection processing.

FIG. 8 is a flowchart illustrating an example of upload condition setting processing.

FIG. 9 is a flowchart illustrating an example of printer driver acquisition processing.

FIG. 10 is a flowchart illustrating an example of upload processing.

FIG. 11 is a flowchart illustrating an example of setup program generation processing.

FIG. 12 is a flowchart illustrating an example of upload monitoring processing.

FIG. 13 is a flowchart illustrating an example of setup program update processing.

FIG. 14 is a flowchart illustrating an example of processing performed by a web server function unit.

FIGS. 15A and 15B illustrate a configuration of a setup program.

FIGS. 16A and 16B illustrate a configuration of an information file when the setup program is started.

FIGS. 17A and 17B illustrate a configuration of an information file for the printer driver installer.

FIG. 18 is a flowchart illustrating an example of processing of the setup program.

### DESCRIPTION OF THE EMBODIMENTS

Various exemplary embodiments, features, and aspects of the invention will be described in detail below with reference to the drawings.

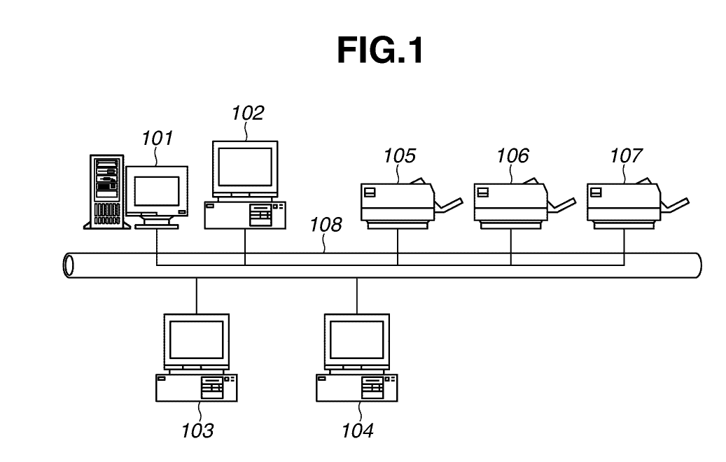

FIG. 1 illustrates an example of a configuration of a printing system according to an exemplary embodiment of the present invention. Except where specifically noted, if a function of the present invention is executed, the present invention can be applied not only to a system but to a single apparatus or a system including a plurality of apparatuses. Further, except where specifically noted, if a function of the present invention is executed, the present invention can be applied to a system which is connected to a network, such as a local area network (LAN) or a wide area network (WAN), and processed.

In FIG. 1, information processing apparatuses 101 to 104 are connected to a network 108 by a network cable such as Ethernet. Further, each of the information processing apparatuses 101 to 104 can execute various programs such as an application program and includes a communication apparatus capable of communicating in a bidirectional manner with an external apparatus connected to the network 108.

The information processing apparatus 101 as a management apparatus (hereinafter referred to as a management apparatus 101 so that it can be distinguished from other information processing apparatuses) retains information of printing apparatuses 105 to 107 and also collects and retains print logs and operation logs of the printing apparatus. Each of the information processing apparatuses 102 to 104 functions as a personal client computer. In the following description, the information processing apparatus 102 is referred to as a client 102 so that it can be distinguished from the management apparatus 101. Further, in the following description, the client 102 is described as a representative apparatus of the information processing apparatuses.

The printing apparatuses (which is also referred to as printers) 105 to 107 are connected to the network 108 via a network interface (not shown). In the following description, the printing apparatus 105 is described as a representative printer. The printing apparatus 105 analyzes a job including print data and transmitted from the clients 102, 103, and 104, converts the data page by page into images, and prints the images one page after another. The printing apparatus 105 can be any printer selected from laser beam printers that employ electrophotography, ink jet printers that employ the ink jet method, and thermal transfer printers. The management apparatus 101, the clients 102, 103, and 104, and the printing apparatuses 105, 106, and 107 are connected to the network 108.

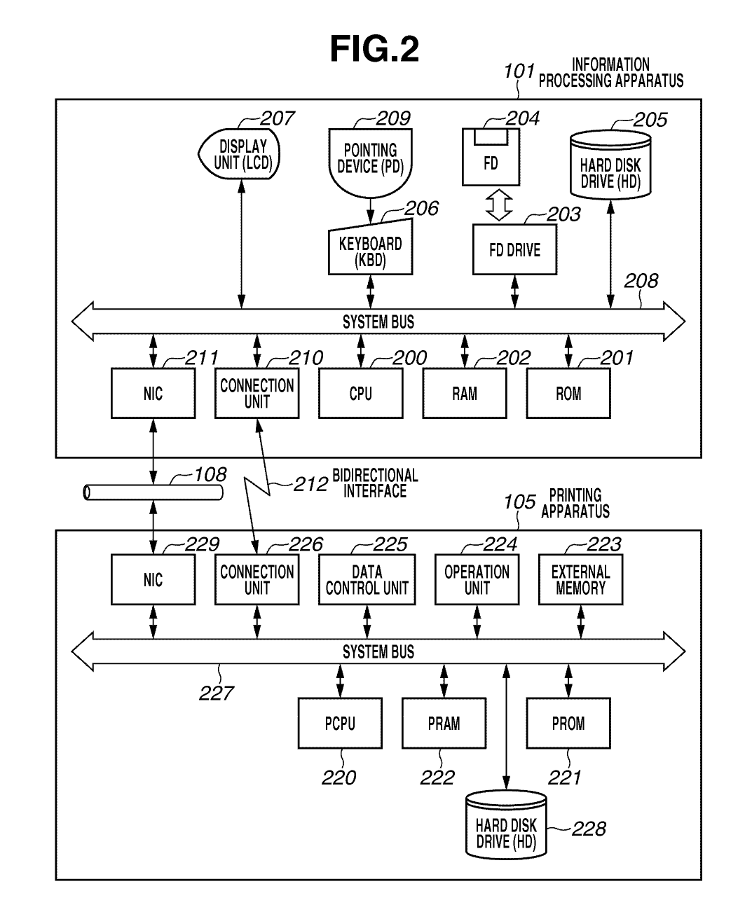

FIG. 2 is a block diagram illustrating an inner configuration of the information processing apparatus 101 and the printing apparatus 105. The configuration of the information processing apparatuses 102 to 104 is similar to that of the information processing apparatus 101. Further, the configuration of the printing apparatuses 106 to 107 is similar to that of the printing apparatus 105. Further, components similar to those illustrated in FIG. 1 are denoted by the same reference numerals and their descriptions are not repeated.

First, the configurations of the information processing apparatus 101 will be described in detail. In FIG. 2, a central processing unit (CPU) 200 is a processor being a control unit of the information processing apparatus. The CPU 200 executes an application program, a printer driver program, an OS, and a network printer control program, all of which are stored in a hard disk drive (HD) 205. Further, the CPU 200 controls temporary storage of information and a file for executing a program in a random access memory (RAM) 202.

A read-only memory (ROM) 201 is a storage unit and stores various types of data being a program such as a basic I/O program, font data used for document processing, and template data. The RAM 202 is a temporary storage unit and functions as a main memory and a work area for the CPU 200.

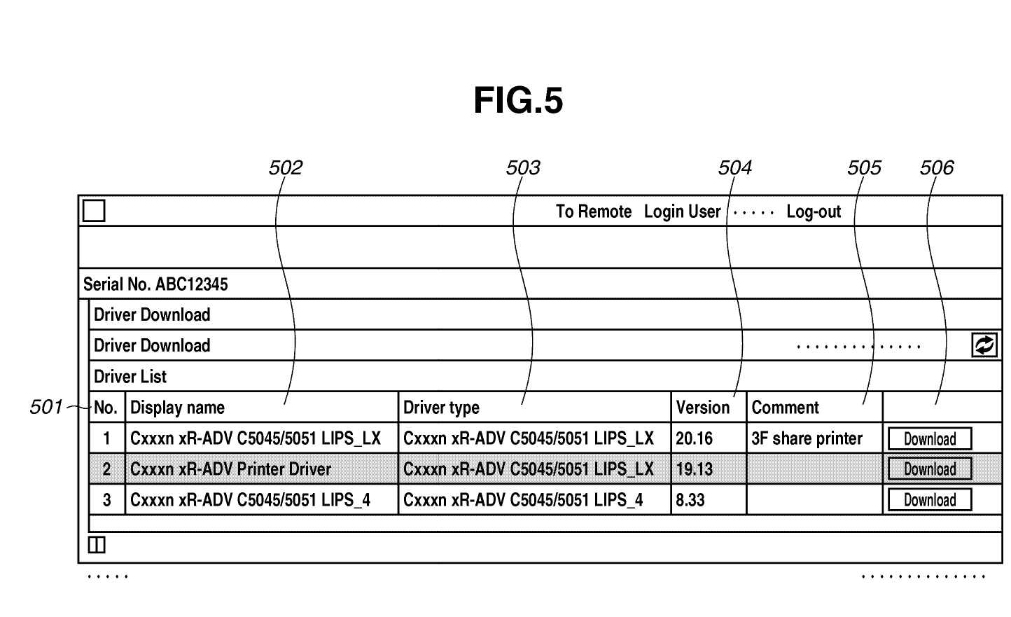

A floppy disk (FD) drive 203 is a storage medium reading unit. As described referring to FIG. 5 below, a program stored in an FD 204 as a storage medium can be loaded onto a computer system being the client via the FD drive 203. The storage medium is not limited to an FD, and an arbitrary storage medium such as a CD-ROM, a compact disc-recordable (CD-R), a compact disc-rewritable (CD-RW), a PC card, a digital versatile disc (DVD), an IC memory card, a magneto-optical disc (MO), or a memory stick can be used. A computer-readable program is stored in the FD 204.

The HD 205 is one of the external storage units and is a hard disk drive that functions as a large capacity memory. An application program, a printer driver program, an OS, a network printer control program, and a related program are stored in the HD 205. Further, the HD 205 includes a spooler. The spooler is a client spooler if it is included in a client and is a server spooler if it is included in a print server. Further, the print server stores job information received from the client. A table used for controlling the sequence is also generated and stored in the HD 205.

A keyboard 206 and a pointing device (PD) 209 function as instruction input units. A display unit 207 is used for displaying a command input via the keyboard 206, a cursor moved by the PD 209, and an output of the OS or the application program.

A system bus 208 is responsible for the flow of data in the computer being a client. A connection unit 210 is responsible for data exchange between the information processing apparatus and an external apparatus (e.g., the printing apparatus 105) via a bidirectional interface 212, which is, for example, a universal serial bus (USB) interface. A network interface card (NIC) 211 is used when the information processing apparatus exchanges data with an external apparatus (e.g., the printing apparatus 105) via the network 108.

Next, the configuration of the printing apparatus 105 will be described in detail. The main components of the printing apparatus 105 include a hard disk drive (HD) 228, a connection unit 226, a data control unit (printer engine) 225, an operation unit 224, an external memory 223, a printer CPU (PCPU) 220, a printer RAM (PRAM) 222, and a printer ROM (PROM) 221. These components are mutually connected via a system bus 227.

The PCPU 220 is a processor that performs overall control of the printing apparatus 105. Based on a control program stored in the PROM 221 or the external memory 223 described below, the PCPU 220 transmits an image signal to the data control unit 225 according to a printer control command (transmission data) received by the connection unit 226. The HD 228 is a large capacity storage device and is used for storing data such as font data and a print job. Further, the HD 228 can be replaced with a storage device (not shown) as an external apparatus. If the HD 228 is replaced with an external storage device, the printing apparatus 105 transmits and receives data to and from the external storage device via the connection unit 226.

The PRAM 222 functions as a main memory of the PCPU 220 and includes a temporary storage area used for storing various types of data. The temporary storage area is used as a work data area when the PCPU 220 controls the printing apparatus. The external memory 223 is also connected as an option. The external memory 223 is used for storing font data, an emulation program, and form data. The PROM 221 is a printer internal memory. As is with the external memory 223, various types of data and a printer control program used for controlling the printing apparatus are stored in the PROM 221.

The data control unit 225 is a printer engine and is controlled by the PCPU 220. According to the PCPU 220 executing a control program stored in the PROM 221 or the external memory 223, the data control unit 225 receives an output image signal via the system bus 227 and performs the actual print processing.

The operation unit 224 includes an input unit, such as an operation panel or an operation switch, and a display unit, such as a light-emitting diode (LED) display or a liquid crystal panel. When the operator operates the operation unit 224, the result is displayed on the display unit. The operator can make and confirm setting of the printing apparatus of the present embodiment via the operation unit 224.

The connection unit 226 is connected to the connection unit 210 of the information processing apparatus 101 via the above-described bidirectional interface 212. According to the connection unit 226, the printing apparatus can receive a print control command (transmission data) sent from the information processing apparatus and can also notify the information processing apparatus of an internal state of the printing apparatus.

A network interface card (NIC) 229 is used for exchanging data with an external apparatus (e.g., one of the information processing apparatuses 101 to 104) via the network 108. The present invention is applicable to a system where the management apparatus 101 and the printing apparatus 105 are connected either via the network 108 or via the bidirectional interface 212.

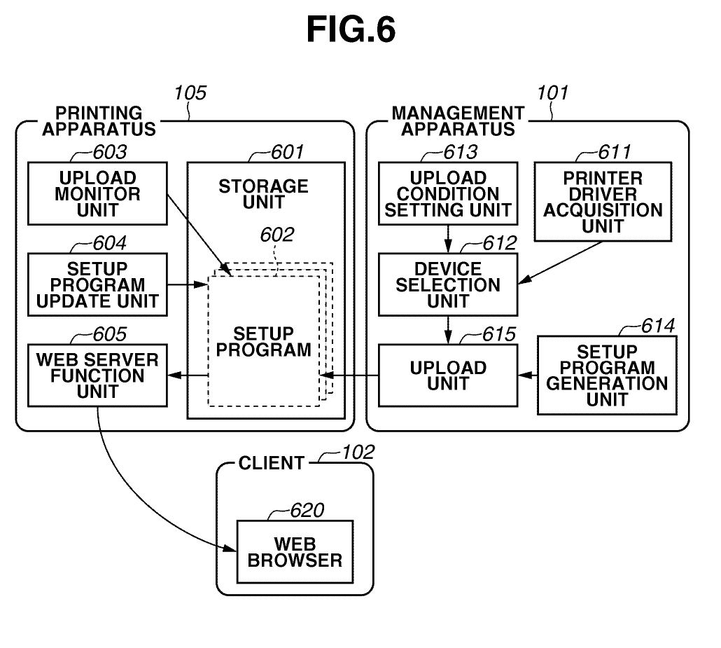

FIG. 6 illustrates a configuration of the main modules of the printing system illustrated in FIG. 1. In the illustration in FIG. 6, the storage device is described as a storage unit included in the printing apparatus so as to simplify the description. As illustrated in FIG. 6, the printing apparatus 105 includes a storage unit 601, an upload monitor unit 603, a setup program update unit 604, and a web server function unit 605. The storage unit 601 corresponds to the HD 228 of the printing apparatus 105. Further, the functions of the upload monitor unit 603, the set up program update unit 604, and the web server function unit 605 correspond to the functions implemented by the PCPU 220 of the printing apparatus 105 reading out and executing an application program stored in the PROM 221 or the external memory 223.

The storage unit 601 can store (register) one or more setup programs 602 which are uploaded from the management apparatus 101. The setup program 602 is an execution program including a printer driver installer and various settings which are used when a logical printer is generated. The one or more setup programs stored in the storage unit 601 include setup programs of different PDLs or versions or customized setup program dedicated to, for example, color printing or 2-in-1 printing.

The upload monitor unit 603 monitors upload of the setup program 602 to the storage unit 601. When the upload is detected, the upload monitor unit 603 requests update of the setup program 602 to the setup program update unit 604. Further, the upload monitor unit 603 monitors configuration information (also called as device information) of the printing apparatus 105. When a change occurs in the configuration information, the upload monitor unit 603 requests the setup program update unit 604 to update the setup program 602. The configuration information is information set for the printing apparatus, such as an IP address, a host name, or an apparatus name.

Based on an instruction given by the upload monitor unit 603, the setup program update unit 604 rewrites internal information (e.g., IP address, host name, or apparatus name) of the setup program 602. The web server function unit 605 operates as a web server. The web server function unit 605 includes a driver download screen illustrated in FIG. 5 described below and provides various web pages in response to a request transmitted from the client 102.

The management apparatus 101 includes a printer driver acquisition unit 611, a device selection unit 612, an upload condition setting unit 613, a setup program generation unit 614, and an upload unit 615. Further, the functions of these units 611 to 615 correspond to the functions implemented by the CPU 200 of the management apparatus 101 reading out and executing an application program stored in the HD 205 or the FD 204.

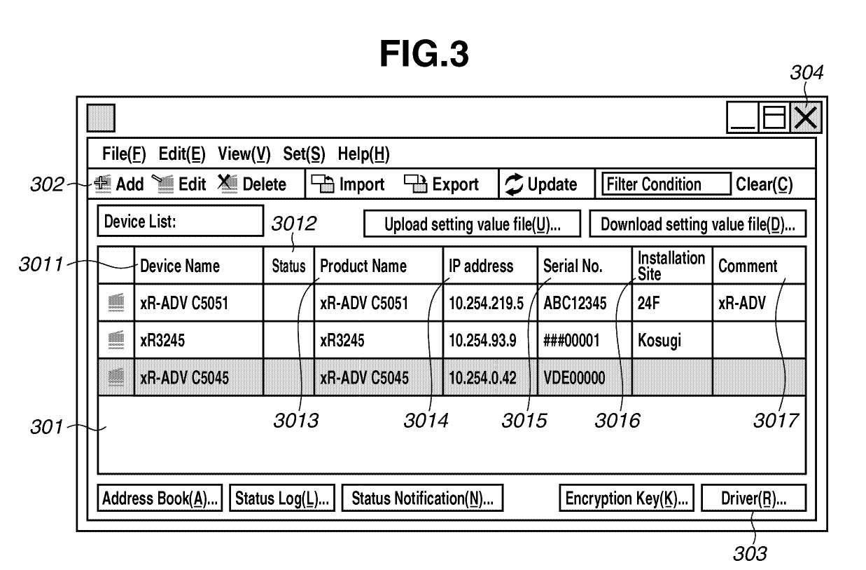

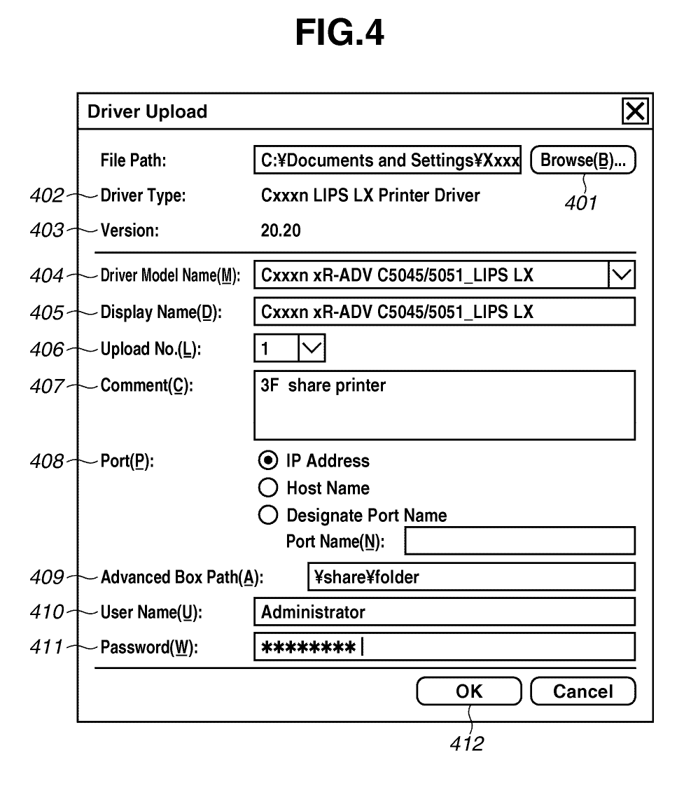

The printer driver acquisition unit 611 is started via an upload condition setting screen illustrated in FIG. 4 described below and retrieves the printer driver installer. The device selection unit 612 displays a device selection screen illustrated in FIG. 3 described below on the display unit 207 of the management apparatus 101 and controls selection of a device.

The upload condition setting unit 613 displays the upload condition setting screen illustrated in FIG. 4 on the display unit 207 of the management apparatus 101 and controls setting of the upload condition. The setup program generation unit 614 generates a setup program. In generating the setup program, the setup program generation unit 614 applies setting information, which is used for the installation, to the printer driver installer acquired by the printer driver acquisition unit 611. The setting information is acquired from the upload condition setting unit 613. The upload unit 615 transmits the setup program generated by the setup program generation unit 614 to the storage unit 601 of the printing apparatus 105.

The client 102 includes a web browser 620. According to an instruction given by the user, the web browser 620 accesses the web server function unit 605 of the printing apparatus 105 and downloads the setup program 602 from the printing apparatus 105 to the client 102. Then, the user can easily install the printer driver in the client 102 by starting the setup program downloaded to the client 102. The web browser 620 is realized by the CPU 200 of the information processing apparatus 102 reading out and executing the web browser program stored in the HD 205 or the FD 204.

FIG. 3 illustrates an example of the device selection screen displayed on the display unit 207 of the management apparatus 101 by the device selection unit 612 of the management apparatus 101. In the device selection screen illustrated in FIG. 3, a device can be added as one of devices managed by the management apparatus 101. When a device is added, a device name 3011, which is the name of the device under the control of the management, is listed in a device list 301 together with attribute information thereof, such as status 3012, product name 3013, IP address 3014, serial No. 3015, installation site 3016, and comment 3017. The above-described device is, for example, a printer (printing apparatus) including a single printing function or a multifunction peripheral including facsimile and copy functions. In the following description, the device is represented by a printer. Further, the user adds the device to be managed by operating an “Add” button 302.

The device name 3011, the product name 3013, the IP address 3014, the serial No. 3015, the installation site 3016, and the comment 3017 are information set for the device. The information is acquired from the device when the management apparatus 101 communicates with the device. The status 3012 is also acquired from the device when the management apparatus 101 communicates with the device. Further, when the user selects a printer from the list (the device list 301) displayed on the device selection screen and further selects a “Driver” button 303, the upload condition setting screen illustrated in FIG. 4 is displayed on the display unit 207 of the management apparatus 101.

FIG. 4 illustrates an example of the upload condition setting screen, which is started via the device selection screen illustrated in FIG. 3 and displayed on the display unit 207 of the management apparatus 101. The upload condition setting screen is displayed by the upload condition setting unit 613.

If the user selects a “browse” button 401 on the upload condition setting screen illustrated in FIG. 4, a file selection dialog (not shown) is displayed on the display unit 207 of the management apparatus 101. Then, if the user designates a “setup.exe” file of a printer driver installer from the file selection dialog, the printer driver acquisition unit 611 reads a driver type and a version of the printer driver installer from the designated “setup.exe” file and a file associated with the “setup.exe” file. Further, the printer driver acquisition unit 611 reflects the driver type and the driver version read by the printer driver acquisition unit 611 in a “driver type:” 402 and a “version:” 403 in the text area of the upload condition setting screen.

Further, the printer driver acquisition unit 611 compares a list of the driver models retained by the printer driver installer and the model names of the printer designated on the device selection screen illustrated in FIG. 3. If a model that matches exists, the name of that model is displayed in a “driver model name” combo box 404. Further, the printer driver acquisition unit 611 sets the driver model name set in the “driver model name” combo box 404 as a default value of a “display name” text box 405. The user can edit and change the name in the “display name” text box 405 to an arbitrary character string. The character string designated in the “display name” text box 405 is displayed on the driver download screen illustrated in FIG. 5 described below. The character string is used by a person that downloads the driver when the person determines whether the driver is the desired driver.

An “upload No.” combo box 406 is used when the user designates a logical number of the printer driver to be uploaded. The logical numbers can be selected from “1” to “3”. If a logical number is already used and, further, if upload is instructed by designating the same number, then the existing uploaded driver is invalidated and the newly uploaded driver will be the effective driver.

According to the present exemplary embodiment, the logical numbers of the printer drivers that can be uploaded is selected from a range of “1” to “3”, and thus three setup programs (e.g., of different PDLs, different versions, or customized) can be stored in the printing apparatus. However, the number of printer drivers that can be uploaded according to the present exemplary embodiment is not limited to three, and a possible range of the logical numbers of the printer drivers that can be uploaded can be set from “1” to “N (an integer of 4 or greater)” and four or more setup programs can be stored in the printing apparatus. Further, the logical numbers of printer drivers that can be uploaded can also be set in a range of “1” to “2” and four setup programs can be stored in the printing apparatus.

The user can input an arbitrary comment in a “comment” text box 407. The character string input in the text box is displayed on the driver download screen described below and helps the person that executes the download determine the target driver. Further, the character string is added as a comment to the property of the printer object generated in the information processing apparatus (the printer object generated in the information processing apparatus is hereinafter referred to as a logical printer).

The user can select a type of the port used in connecting the logical printer from a “port” 408. The user can select the port type from the radio buttons being “IP address”, “host name”, and “designate port name”. If the user selects the “designate port name” radio button, the user can input an arbitrary port name in a “port name” text box.

The user designates a path to the storage unit to which the printer driver is uploaded by using an “advanced box path” text box 409. Further, the user designates a name of a user who has the right to access the path designated by the “advanced box path” text box 409 in a “user name” text box 410. Furthermore, the user designates a password of the user who has the right to access the path designated by the “advanced box path” text box 409 in a “password” text box 411.

Further, if the user selects an OK button 412, the upload condition setting unit 613 constructs a setup program for the printer driver installer designated by the file selection dialog. The display name and the upload No. are reflected in the setup program when it is constructed. The upload unit 615 uploads the constructed setup program to the storage unit 601 of the printing apparatus 105.

FIG. 5 illustrates an example of the driver download screen displayed on the display unit 207 of the client 102 when the web server function unit 605 of the printing apparatus 105 is accessed by the web browser 620 of the client 102. On the driver download screen illustrated in FIG. 5, a list of the setup programs 602 uploaded to the storage unit 601 of the printing apparatus 105 is displayed together with a driver “No.” 501, a “display name” 502, a “driver type” 503, a “version” 504, a “comment” 505, and a “download” button 506.

In the row of the driver “No.” 501, a number designated via the “upload No.” combo box 406 of the driver upload condition setting screen is displayed. In the row of the “display name” 502, a character string designated via the “display name” text box 405 of the upload condition setting screen is displayed. In the row of the “driver type” 503, a character string set in the “driver type:” 402 of the upload condition setting screen is displayed. In the row of the “version” 504, a version number set in the “version:” 403 of the upload condition setting screen is displayed. In the row of the “comment” 505, a character string designated via the “comment” text box 407 of the upload condition setting screen is displayed. When the “download” button 506 is selected by the user, a download dialog (not shown) is displayed and a setup program corresponding to the upload No. is downloaded to the download directory.

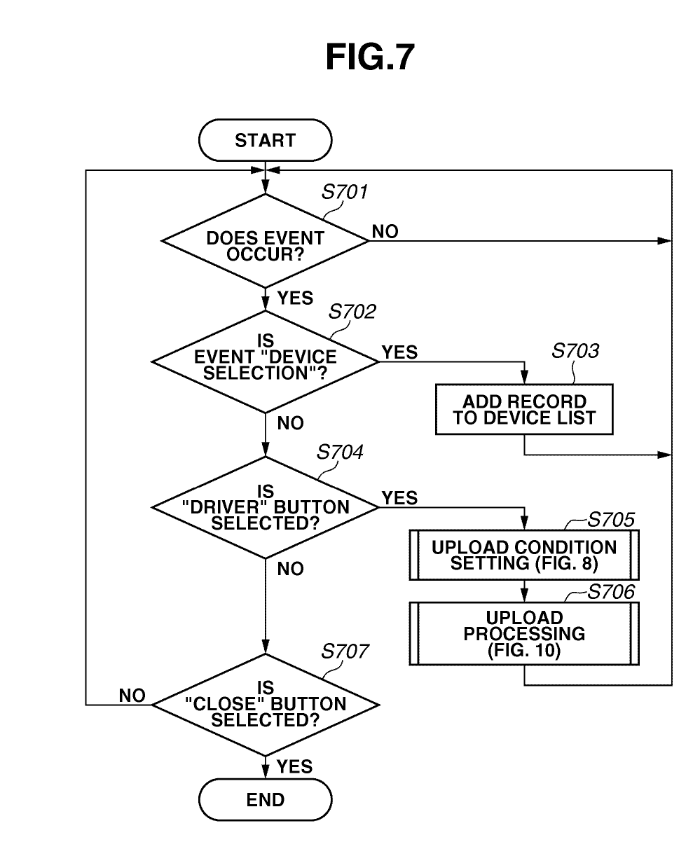

Next, the basic flow of the device selection unit 612 will be described with reference to FIG. 7. FIG. 7 is a flowchart illustrating an example of the device selection processing performed by the device selection unit 612. In order to simplify the description, in the flowchart in FIG. 7, the program related to the device selection unit 612 is described on the assumption that it is installed in the HD 205 of the management apparatus 101, loaded into the RAM 202, and executed by the CPU 200. Further, the device selection screen is described on the assumption that it is also displayed on the display unit 207 of the management apparatus 101 and the devices displayed on the device selection screen are all printing apparatuses (printers).

In step S701, the device selection unit 612 determines whether an event has occurred. For example, according to a method discussed in Microsoft Developer Network (MSDN) Library (registered trademark), an operation such as a click of a mouse or a keyboard input and an ID that uniquely defines each resource such as a button in the window or a list box are notified to the device selection unit 612 as an event. If an event has not occurred (NO in step S701), the processing in step S701 is repeated. On the other hand, if an event has occurred (YES in step S701), the processing proceeds to step S702. In step S702, the device selection unit 612 determines whether the event is “device selection”. In this step, if the event includes an ID that indicates a record in the device list 301 on the device selection screen illustrated in FIG. 3 and an ID of a left button operation of the PD 209, the device selection unit 612 determines that the event is “device selection”.

In step S702, if the event is “device selection” (YES in step S702), the processing proceeds to step S703. In step S703, the device selection unit 612 adds a record to a printer list in a work area allocated in advance in a storage device such as the RAM 202 or the HD 205. The printer list includes information unique to the printer such as a printer model name and an IP address of the selected device. Then, the processing returns to step S701.

On the other hand, in step S702, if the event is not “device selection” (NO in step S702), the processing proceeds to step S704. In step S704, the device selection unit 612 determines whether the event is selecting the “driver” button. In this step, if the event includes an ID that indicates the “driver” button 303 on the device selection screen illustrated in FIG. 3 and an ID of a left button operation of the PD 209, the device selection unit 612 determines that the event is selecting the “driver” button.

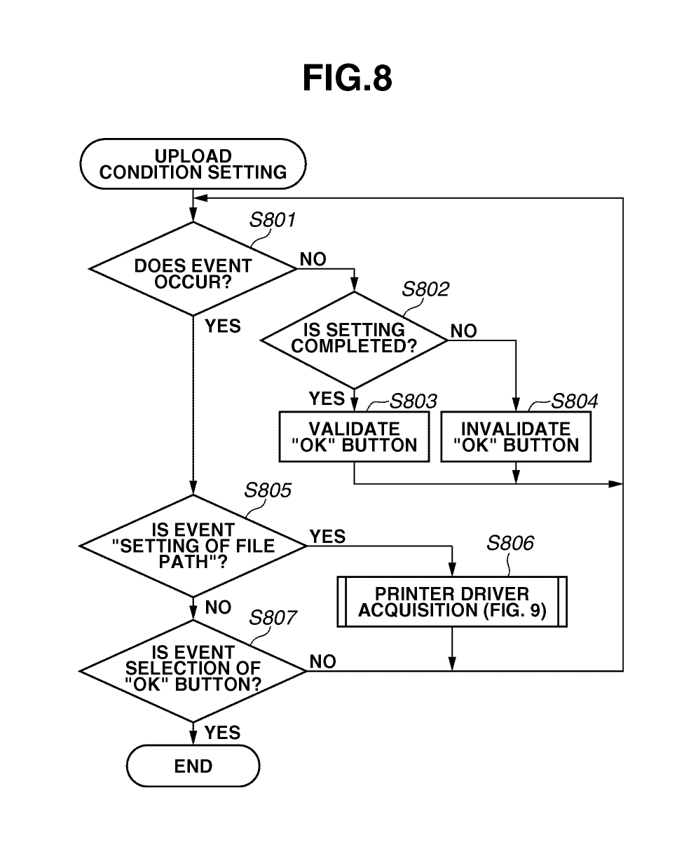

In step S704, if the event is selecting the “driver” button (YES in step S704), the processing proceeds to step S705. In step S705, the device selection unit 612 displays the upload condition setting screen illustrated in FIG. 4 on the display unit 207 of the management apparatus 101 and transmits the printer list generated in step S703 to the upload condition setting unit 613. Then, the upload condition setting unit 613 performs upload condition setting processing in FIG. 8 described below. While the upload condition setting processing is performed, acquisition of the printer driver installer is also performed by the printer driver acquisition unit 611.

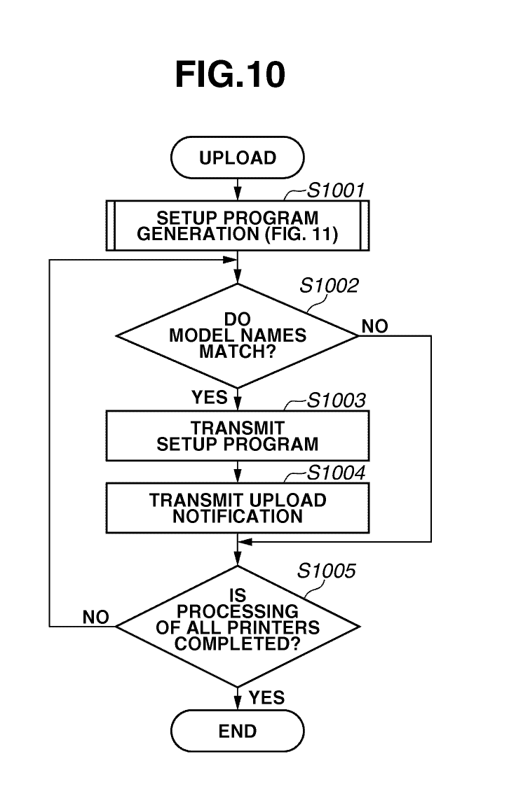

When the processing in step S705 is completed, the processing proceeds to step S706. In step S706, the device selection unit 612 transmits the device list generated in step S703 as well as the information of the printer driver installer and the upload condition acquired in step S705 to the upload unit 615. Then, the upload unit 615 performs upload processing described below (see FIG. 10) using the device list, the printer driver installer, and the upload condition processing information. When the processing in step S706 is completed, the processing returns to step S701.

On the other hand, in step S704, if the event is not selecting the “driver” button (NO in step S704), the processing proceeds to step S707. In step S707, the device selection unit 612 determines whether the event is selecting the “end” button. In this step, if the event includes an ID that indicates the “end” button (icon) 304 on the device selection screen illustrated in FIG. 3 and an ID of the left button operation of the PD 209, the device selection unit 612 determines that the event is selecting the “end” button.

In step S707, if the event is selecting the “end” or “close” button (YES in step S707), then based on a predetermined procedure, the device selection unit 612 de-allocates the work area allocated in the storage unit such as the RAM 202 or the HD 205, and then the processing ends. On the other hand, in step S707, if the event is not selecting the “end” or “close” button (NO in step S707), then the processing returns to step S701.

Next, the upload condition setting processing in step S705 in FIG. 7 will be described with reference to FIG. 8. FIG. 8 is a flowchart illustrating an example of the upload condition setting processing performed by the upload condition setting unit 613. In order to simplify the description, in the flowchart in FIG. 8, the program related to the upload condition setting unit 613 is described on the assumption that it is installed in the HD 205 of the management apparatus 101, loaded into the RAM 202, and executed by the CPU 200. Further, the upload condition setting screen illustrated in FIG. 4 is displayed on the display unit 207 of the management apparatus 101.

In step S801, the upload condition setting unit 613 determines whether an event has occurred.

In step S801, if an event has not occurred (NO in step S801), the processing proceeds to step S802. In step S802, the upload condition setting unit 613 determines whether the setting of the upload condition is completed. In this step, if values are set with respect to all items on the upload condition setting screen illustrated in FIG. 4, the upload condition setting unit 613 determines that the setting is completed.

In step S802, if the setting is completed (YES in step S802), the processing proceeds to step S803. In step S803, the upload condition setting unit 613 validates the “OK” button 412 of the upload condition setting screen illustrated in FIG. 4, and then the processing returns to step S801. On the other hand, in step S802, if the setting is not completed (NO in step S802), the processing proceeds to step S804. In step S804, the upload condition setting unit 613 invalidates the “OK” button 412 of the upload condition setting screen illustrated in FIG. 4, and the processing returns to step S801.

On the other hand, in step S801, if an event has occurred (YES in step S801), the processing proceeds to step S805. In step S805, the upload condition setting unit 613 determines whether the event is setting of a “file path”. In this step, if the event includes an ID that indicates the “browse” button 401 on the upload condition setting screen illustrated in FIG. 4 and an ID of a left button operation of the PD 209, the upload condition setting unit 613 determines that the event is setting of a “file path”.

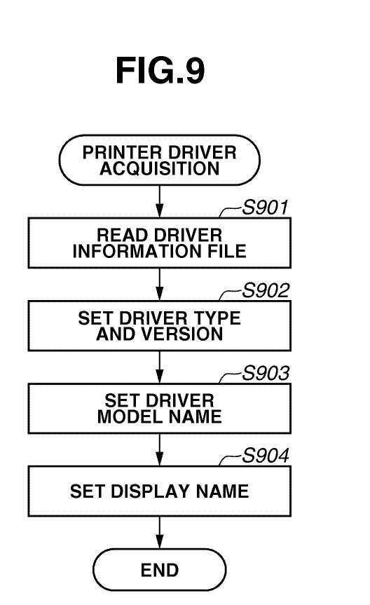

In step S805, if the event is setting of a “file path” (YES in step S805), the processing proceeds to step S806. In step S806, the upload condition setting unit 613 displays a file selection dialog (not shown) on the display unit 207 of the management apparatus 101 and if a “setup.exe” file of the printer driver installer is designated by the user via the file selection dialog, the upload condition setting unit 613 invokes the printer driver acquisition unit 611. Then, the printer driver acquisition unit 611 performs printer driver acquisition processing described below with reference to FIG. 9. When the printer driver acquisition processing in step S805 is completed, the processing returns to step S801.

On the other hand, in step S805, if the event is not setting of a “file path” (NO in step S805), the processing proceeds to step S807. In step S807, the upload condition setting unit 613 determines whether the event is selecting the “OK” button. In this step, if the event includes an ID that indicates the “OK” button 412 on the upload condition setting screen illustrated in FIG. 4 and an ID of a left button operation of the PD 209, the upload condition setting unit 613 determines that the event is selecting the “OK” button. In step S807, if the event is not selecting the “OK” button (NO in step S807), the processing returns to step S801. On the other hand, in step S807, if the event is selecting the “OK” button (YES in step S807), the upload condition setting processing ends.

Next, the printer driver acquisition processing in step S806 in FIG. 8 will be described with reference to FIG. 9. FIG. 9 is a flowchart illustrating an example of the printer driver acquisition processing performed by the printer driver acquisition unit 611. In order to simplify the description, in the flowchart in FIG. 9, the program related to the printer driver acquisition unit 611 is described on the assumption that it is installed in the HD 205 of the management apparatus 101, loaded into the RAM 202, and executed by the CPU 200.

In step S901, the printer driver acquisition unit 611 reads a driver information file. More specifically, the printer driver acquisition unit 611 acquires path information of the “setup.exe” file designated by the user using the file selection dialog (not shown), and searches for a driver information file (setup.inf) from the path information. If a driver information file is found, the printer driver acquisition unit 611 examines the file according to a predetermined format and extracts the version information and the driver type information. Then, the printer driver acquisition unit 611 stores the extracted information in a work area allocated in advance in a storage unit such as the RAM 202.

In step S902, the printer driver acquisition unit 611 writes the driver type information and the version information acquired in step S901 in the “driver type:” 402 and the “version:” 403 in the text area of the upload condition setting screen displayed on the display unit 207 of the management apparatus 101.

In step S903, the printer driver acquisition unit 611 sets a driver model name. More specifically, the driver acquisition unit 611 searches the driver information file and searches for a driver model name that matches the printer. For example, according to the method discussed in Microsoft Developer Network (MSDN) Library (registered trademark), a driver model name and a hardware ID are described in one entry in a model section of the driver information file (setup.inf). According to the description, from the driver information file read in step S901, all the descriptions including the same hardware ID as the ID of the printer selected from the device list 301 is searched, and the driver model names are obtained. Then, the driver model names are set as candidate models for the list of the “driver model name” combo box 404 displayed on the upload condition setting screen. The candidate that heads the list is displayed in a selective state.

The driver model name set in step S903 is a driver model name (printer model name) of the device at the top of the device list 301 displayed on the device selection screen illustrated in FIG. 3. Further, if a driver model name is not found, all the driver model names in the driver information file are determined to be candidates of the list of the “driver model name” combo box 404, and no driver model is displayed in a selective state.

In step S904, the printer driver acquisition unit 611 sets the driver model name at the top of the list of the “driver model name” combo box 404 set in step S903 as the display name displayed in the “display name” text box 405, and then the printer driver acquisition processing ends.

Next, the upload processing in step S706 in FIG. 7 will be described with reference to FIG. 10. FIG. 10 is a flowchart illustrating an example of the upload processing performed by the upload unit 615. In order to simplify the description, in the flowchart in FIG. 10, the program related to the upload unit 615 is described on the assumption that it is installed in the HD 205 of the management apparatus 101, loaded into the RAM 202, and executed by the CPU 200. Further, the device list (printer list), which is a list of devices that can be uploaded, the printer driver installer, and information for the upload are transmitted to the upload unit 615 from the device selection unit 612 and stored in the work area of the storage area allocated in the RAM 202. The information for the upload processing is the upload conditions set in step S705 in FIG. 7.

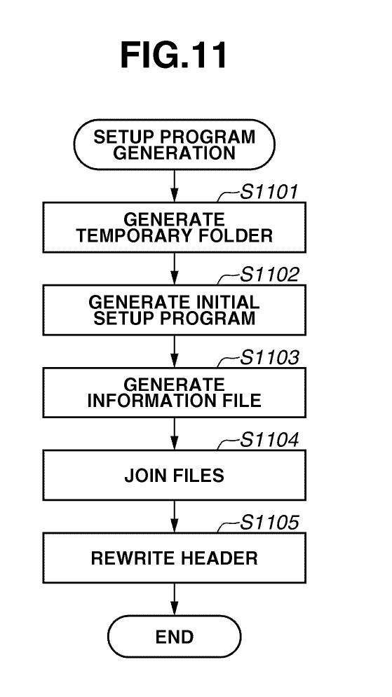

In step S1001, the upload unit 615 invokes the setup program generation unit 614 and transmits the information (the upload conditions set in step S705 in FIG. 7) and the printer driver installer to be uploaded to the setup program generation unit 614. Then, the setup program generation unit 614 performs setup program generation processing described below (FIG. 11).

In step S1002, the upload unit 615 determines whether a device in the printer list transmitted from the device selection unit 612 matches a model name of a driver of the setup program generated in step S1001. In step S1002, if a model name of one printer selected from the printer list matches a model name of a driver of the setup program generated in step S1001, it is determined that they are matching model names. Further, if a model name of a printer is “Cxxxn xR-ADV C5051” and a model name of a driver is “Cxxxn xR-ADV C5051/5041 LIPS LX”, which includes the printer model name, it is also determined that they are matching model names.

In step S1002, if the model names match (YES in step S1002), the processing proceeds to step S1003. In step S1003, the upload unit 615 transmits the setup program generated in step S1001 to the printing apparatus 105 via the network 108 (or the bidirectional interface 212). In other words, the upload unit 615 sets (registers) the setup program generated by the setup program generation unit 614 in step S1001 in the storage unit 601 of the printing apparatus 105 according to the setting values (the “advanced box path” text box 409, the “user name” text box 410, and the “password” text box 411) set on the upload condition setting screen.

In step S1004, the upload unit 615 transmits an upload notification to the printing apparatus 105 via the network 108 (or the bidirectional interface 212). In other words, by using a communication unit (the NIC 211 or the connection unit 210) which has been prepared according to a predetermined procedure in advance, the upload unit 615 notifies the printing apparatus 105 of the path and the file name and information for generating a download page, which have been uploaded to the printing apparatus 105. The information for the generation of the download page is stored in the printing apparatus and corresponds to the “upload No.” combo box 406, the “display name” text box 405, the “driver type:” 402, the “version:” 403, and the “comment” text box 407 in FIG. 4. Then, the processing proceeds to step S1005.

On the other hand, in step S1002, if the model names do not match (NO in step S1002), then the processing proceeds to step S1005. In step S1005, the upload unit 615 determines whether the above-described processing has been completed with respect to all printers. In step S1005, if the processing has not been completed with respect to all printers (NO in step S1005), the processing returns to step S1002. On the other hand, in step S1005, if the processing with respect to all printers has been completed (YES in step S1005), then the upload processing ends.

Next, the setup program generation processing in step S1001 in FIG. 10 will be described with reference to FIGS. 11, 15A, 15B, 16A, and 17A. FIG. 11 is a flowchart illustrating an example of the setup program generation processing performed by the setup program generation unit 614. In order to simplify the description, in the flowchart in FIG. 11, the program related to the setup program generation unit 614 is described on the assumption that it is installed in the HD 205 of the management apparatus 101, loaded into the RAM 202, and executed by the CPU 200. Further, information for the generation of the setup program and the printer driver installer are transmitted from the upload unit 615 as needed, and maintained in the work area allocated in the storage area of the RAM 202. The information for the generation of a setup program is the upload condition set in step S705 in FIG. 7.

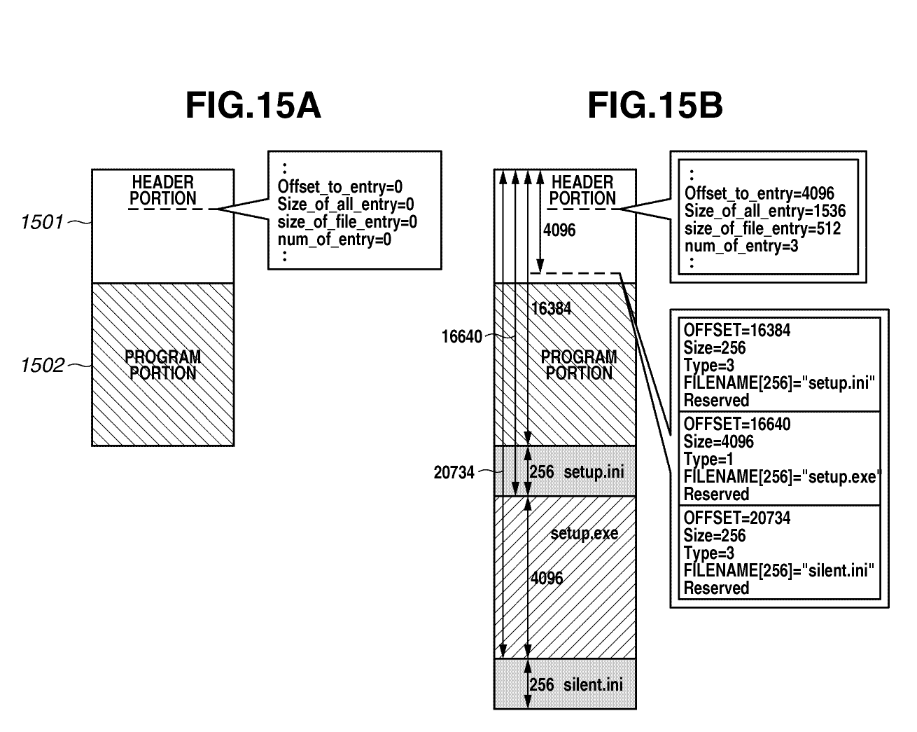

In step S1101, the setup program generation unit 614 generates a temporary folder. For example, by using a function provided by the OS, a folder is generated in a work area allocated in the storage area of the management apparatus 101 such as the RAM 202 or the HD 205. In step S1102, the setup program generation unit 614 generates an initial setup program illustrated in FIG. 15A in the temporary folder generated in step S1101. The initial setup program will now be described with reference to FIG. 15A.

FIG. 15A illustrates a configuration of an initial setup program. FIG. 15B illustrates a configuration of a setup program after the printer driver installer is joined to the initial setup program. As illustrated in FIG. 15A, the initial setup program includes a header portion 1501 and a program portion 1502.

As illustrated in FIG. 15A, various parameters used for determining the operations of the program portion are stored in the header portion 1501. The parameters are, for example, Offset_to_entry, Size_of_all_entry, size_of_file_entry, and num_of_entry. The Offset_to_entry is a parameter that indicates an offset of the area where the information of the joined file is stored from the top of the setup program. The Size_of_all_entry is a parameter that indicates a total size of the areas where the information of the joined file is stored. The size_of_file_entry is a parameter that indicates a size of an area where the information of the joined file is stored. The num_of_entry is a parameter that indicates a total number of the areas where the information of the joined file is stored. Since the initial setup program does not have a joined file, “0” is set for each of the above-described parameters. A program used for referencing the header, identifying a position of the joined file, splitting the joined printer driver installer described below, and starting the printer driver installer is stored in the program portion 1502.

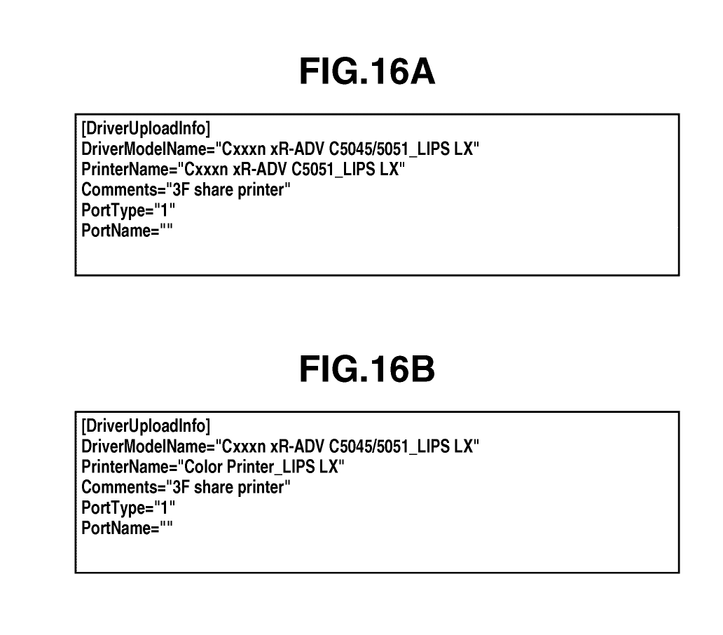

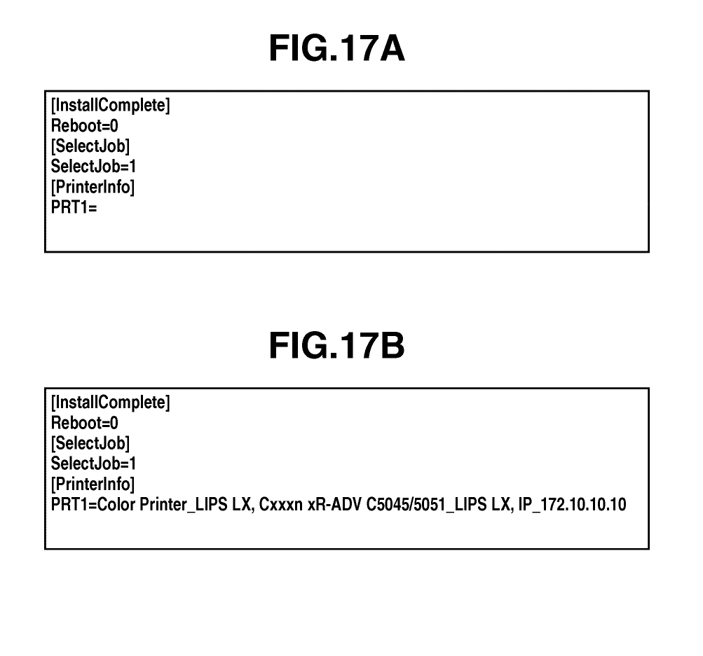

Referring back again to the flowchart in FIG. 11, in step S1103, the setup program generation unit 614 generates information files (“setup.ini” and “silent.ini”) illustrated in FIGS. 16A and 17A in the temporary folder generated in step S1101. The information files will now be described with reference to FIGS. 16A, 16B, 17A, and 17B.

FIGS. 16A and 16B illustrate examples of a configuration of an information file for staring a setup program. The information files illustrated in FIGS. 16A and 16B include information for starting a setup program and information for generating a download page described below. The file name is “setup.ini”.

FIG. 16A corresponds to the information file “setup.ini” just after the generation of the setup program. FIG. 16B corresponds to the information file “setup.ini” after the update of the setup program. As can be seen from FIGS. 16A and 16B, the information file “setup.ini” includes a [DriverUploadInfo] section which is used for setting DriverModelName, PrinterName, Comments, PortType, and PortName.

The DriverModelName indicates a driver model name. In step S1103, the driver model name displayed in the “driver model” combo box 404 on the upload condition setting screen in FIG. 4 is set for the DriverModelName. The PrinterName indicates a name of a logical printer installed in the PC. In step S1103, the display name displayed in the “display name” text box 405 on the upload condition setting screen in FIG. 4 is set for the PrinterName. The Comments indicates a comment set for the logical printer installed in the PC. In step S1103, the comment displayed in the “comment” text box 407 on the upload condition setting screen in FIG. 4 is set for the Comments. The PortType indicates a port type (1: IP address, 2: host name, or 3: port name). In step S1103, the port type displayed in the “port” 408 on the upload condition setting screen in FIG. 4 is set for the PortType. The PortName indicates a port name in the upload condition setting screen, which is effective only when PortType=3. In step S1103, the port name in the upload condition setting screen displayed in the “port” 408 on the upload condition setting screen in FIG. 4 is set for the PortName. According to the example illustrated in FIG. 16A, the driver model is “Cxxxn xR-ADV C5045/5051 LIPS LX”, the printer name is “Cxxxn xR-ADV C5051_LIPSLX”, the comment is “3F share printer”, and the port type is IP address.

FIGS. 17A and 17B illustrate examples of a configuration of an information file for the printer driver installer. The information files illustrated in FIGS. 17A and 17B are files including information for the printer driver installer, which has been split from the joined setup program. The name of the information files is “silent.ini”. FIG. 17A corresponds to the information file “silent.ini” just after the generation of the setup program and FIG. 17B corresponds to the information file “silent.ini” after the update.

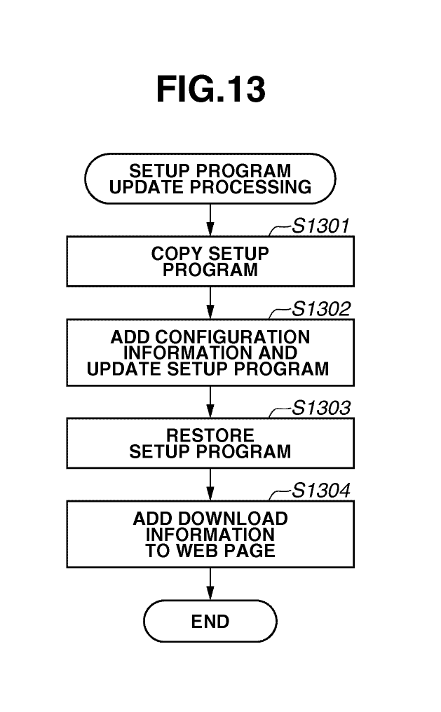

As can be seen from FIGS. 17A and 17B, the information file “silent.ini” includes sections such as [InstallComplete], [SelectJob], and [PrinterInfo] used for setting Reboot, SelectJob, and PRT1, respectively. The Reboot corresponds to a flag (0: no reboot, 1: reboot) used for controlling reboot of the PC after the install processing is completed. The SelectJob corresponds to an install mode (0: new install, 1: overwrite install, 2: no install) of the printer driver. The PRT1 designates a printer name, a driver model, and a connection port. According to the example illustrated in FIG. 17A, “no reboot” and “overwrite install” are designated (set in step S1103 in FIG. 11). The printer name, the driver model, and the connection port are not yet set at the initial state (at the time in step S1103 in FIG. 11). These items that are not set are set according to setup program update processing described below with reference to FIG. 13.

Now, referring back again to the flowchart in FIG. 11, in step S1104, the setup program generation unit 614 joins the information files (“setup.ini” and “silent.ini”) generated in step S1103 and the driver installer (“setup.exe”) acquired in step S806 in FIG. 8 to the initial setup program generated in step S1102.

In step S1105, the setup program generation unit 614 rewrites the header portion 1501 of the setup program (illustrated in FIG. 15A) which has been generated in step S1104. The header portion 1501 is rewritten, for example, as illustrated in FIG. 15B. In other words, “4096”, which is the offset value of the area where the information of the joined file is stored from the top of the setup program, is set for the Offset_to_entry in the header portion 1501. Further, “1536”, which is the total size of the areas where the information of the joined file is stored, is set for the Size_of_all_entry. Furthermore, “512”, which is the size of the area where the information of the joined file is stored, is set for the size_of_file_entry. Further, “3”, which is a total number of the areas where the information of the joined files is stored, is set for the num_of_entry.

Additionally, three areas where the information of the joined files is stored are allocated in an area designated by the Offset_to_entry, and then the information of the joined files is stored in the allocated three areas. The order of the joined files is, from the top to the end, the information file “setup.ini” generated in step S1103, the printer driver installer acquired by the printer driver acquisition unit 611 and transmitted from the upload unit 615, and the information file “silent.ini” generated in step S1103.

As information of each file, parameters of OFFSET, Size, Type, and FILENAME are set for each area corresponding to the files. An offset position of the joined file with respect to the top of the setup program is set for the OFFSET. A size of the joined file is set for the Size. A type of the joined file (1: executable file, 2: temporary file, 3: information file, or 4: others) is set for the Type. A name of the joined file is set for the FILENAME. When the processing in step S1105 (the header rewriting of the setup program) is completed, the setup program generation processing ends.

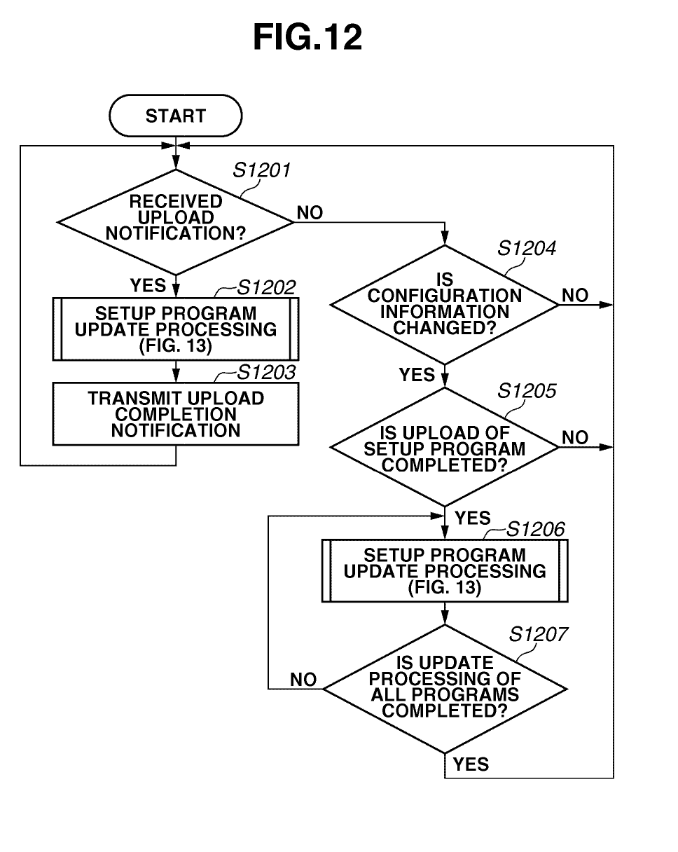

Next, upload monitoring processing performed by the upload monitor unit 603 of the printing apparatus 105 will be described with reference to FIG. 12. FIG. 12 is a flowchart illustrating an example of upload monitoring processing performed by the upload monitor unit 603 of the printing apparatus 105. The program related to the upload monitor unit 603 is described on the assumption that it is loaded from the PROM 221 of the printing apparatus 105 into the PRAM 222 and executed by the PCPU 220.

In step S1201, the upload monitor unit 603 determines whether an upload notification has been transmitted from the management apparatus 101. In this step, packets which are transmitted via the network 108 (or the bidirectional interface 212) and the NIC 229 (or the connection unit 226) based on predetermined procedures and received are searched. If an upload notification in a predetermined format is determined, the upload monitor unit 603 determines that the upload notification has been transmitted.

In step S1201, if an upload notification is determined (YES in step S1201), the processing proceeds to step S1202. In step S1202, the upload monitor unit 603 invokes the setup program update unit 604. Simultaneously, the upload monitor unit 603 transmits the path, the file name, and the information for generating a download page, which have been acquired according to the upload notification as well as configuration information described below to the setup program update unit 604. Then, the setup program update unit 604 performs the setup program update processing described below with reference to FIG. 13. The information for generating a download page is included in the upload notification and corresponds to the “upload No.” combo box 406, the “display name” text box 405, the “driver type:” 402, the “version:” 403, and the “comment” text box 407 in FIG. 4.

When the setup program update processing is completed, then in step S1203, the upload monitor unit 603 performs upload completion notification. In other words, based on a predetermined method, the upload monitor unit 603 transmits an upload completion notification generated in a predetermined format to the source of the upload notification determined in step S1201 via the connection unit 226. Then, the processing returns to step S1201.

In step S1201, if an upload notification is not determined (NO in step S1201), the processing proceeds to step S1204. In step S1204, the upload monitor unit 603 determines whether the configuration information has been changed. In this step, the upload monitor unit 603 sequentially reads out information stored in a specified area of a storage unit such as the PRAM 222 and determines that the configuration information has been changed if the information is different from the information obtained the previous time. The configuration information is, for example, an IP address or an apparatus name being a nickname of the apparatus, which can be changed by the administrator.

In step S1204, if the configuration information is not changed (NO in step S1204), the processing returns to step S1201. On the other hand, in step S1204, if the configuration information is changed (YES in step S1204), the processing proceeds to step S1205. In step S1205, the upload monitor unit 603 determines whether the upload of the setup program is completed. In this step, the upload monitor unit 603 reads out management information of an upload-completed setup program stored in advance in a storage unit such as the HD 228. If information of one or more upload-completed setup programs exists, the upload monitor unit 603 determines that the upload of the setup program is completed.

In step S1205, if the upload of the setup program has been completed (YES in step S1205), the processing proceeds to step S1206. In step S1206, the upload monitor unit 603 invokes the setup program update unit 604. Simultaneously, the upload monitor unit 603 reads out information of one setup program which has not been updated yet from the management information of the setup program. Then, the upload monitor unit 603 transmits the path, the file name, and the information for generating the download page, which have been read out as well as the configuration information acquired in step S1204 to the setup program update unit 604. Then, the setup program update unit 604 performs the setup program update processing described below with reference to FIG. 13.

When the setup program update processing is completed, then in step S1207, the upload monitor unit 603 determines whether the update processing of all the upload-completed setup programs has been completed. In this step, the upload monitor unit 603 searches the above-described management information of the setup programs, and if a setup program which is not yet updated does not exist, the upload monitor unit 603 determines that the update processing of all the upload-completed setup programs has been completed.

In step S1207, if the update processing of all the upload-completed setup programs has not been completed yet (NO in step S1207), the processing returns to step S1206. On the other hand, in step S1207, if the update processing of all the upload-completed setup programs has been completed (YES in step S1207), the processing returns to step S1201. Further, in step S1205, if the setup program is not an upload-completed setup program (NO in step S1205), then the processing also returns to step S1201.

Next, the setup program update processing performed by the setup program update unit 604 of the printing apparatus 105 will be described with reference to FIG. 13. FIG. 13 is a flowchart illustrating an example of the setup program update processing performed by the setup program update unit 604 of the printing apparatus 105. The program related to the setup program update unit 604 is invoked from the PROM 221 of the printing apparatus 105 to the PRAM 222 and executed by the PCPU 220. Further, the path, the file name, and the information for generating the download page transmitted from the upload monitor unit 603 as well as information for updating the setup program are stored in a work area allocated in the PRAM 222 in advance.

In step S1301, the setup program update unit 604 searches a corresponding setup program stored in the storage unit 601 based on a path and a file name transmitted from the upload monitor unit 603, and copies the setup program in a work area allocated in a storage unit such as the PRAM 222.

In step S1302, the setup program update unit 604 reflects (updates) the configuration information transmitted from the upload monitor unit 603 in the setup program copied in step S1301. For example, if an IP address being “172.10.10.10” and an apparatus name being “Color Printer” are to be reflected, the information files “setup.ini” and “silent.ini” joined to the setup program copied in step S1301 are updated as illustrated in FIGS. 16B and 17B. More specifically, the apparatus name “Color Printer” is reflected in “PrinterName=Cxxxn xR-ADV C5045/5051_LIPS LX” of the [DriverUploadInfo] section of the “setup.ini” so that “Color Printer_LIPS LX” is set for the PrinterName. Further, the apparatus name “Color Printer” and the IP address “172.10.10.10” are reflected in the [PrinterInfo] section of “PRT1=” of the “silent.ini” so that “PRT1=Color Printer_LIPS LX, Cxxxn xR-ADV C5045/5051 LIPS LX, 172.10.10.10” is set. The driver model name at that time, which is “Cxxxn xR-ADV C5045/5051 LIPS LX”, is acquired from the information file “setup.ini”.

In step S1303, the setup program update unit 604 overwrites and stores (restores) the setup program updated in step S1302 on the original setup program copied in step S1301. In step S1304, the setup program update unit 604 writes the download information on a web page, de-allocates the work area, and terminates the setup program update processing. If the download information written on the above-described web page is acquired via the web browser, the driver download screen is displayed on the web browser as illustrated in FIG. 5.

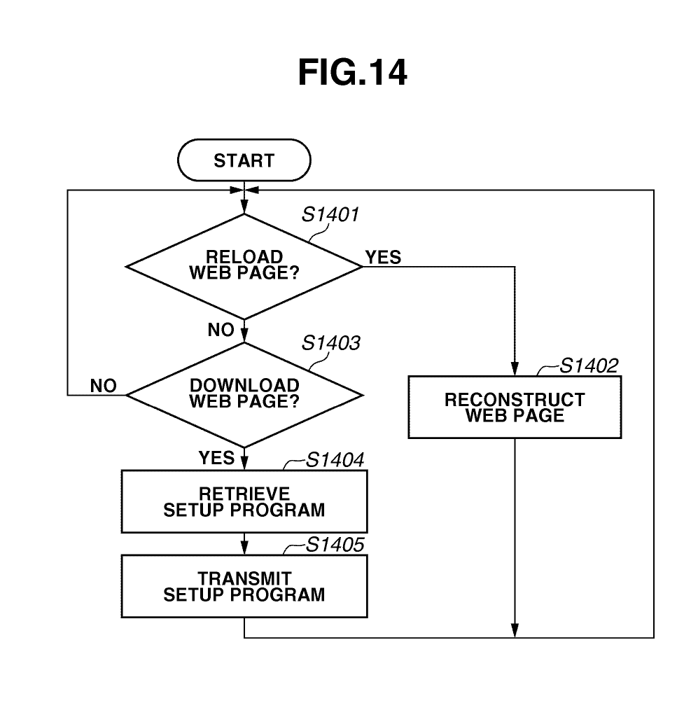

Next, the processing of the web server function unit 605 of the printing apparatus 105 will be described with reference to FIG. 14. FIG. 14 is a flowchart illustrating an example of the processing performed by the web server function unit 605 of the printing apparatus 105. The program related to the web server function unit 605 is invoked from the PROM 221 of the printing apparatus 105 to the PRAM 222 and executed by the PCPU 220. In step S1401, the web server function unit 605 determines whether reloading is designated by the user. In other words, the web server function unit 605 searches packets received via the connection unit 226 and determines whether a reload request is included. If a reload request is included, the web server function unit 605 determines that reloading has been instructed.

In step S1401, if reloading has been instructed (YES in step S1401), the processing proceeds to step S1402. In step S1402, the web server function unit 605 reconstructs the web page and transmits the reconstructed web page to the web browser 620 based on a predetermined procedure. On the other hand, in step S1401, if reloading has not been instructed (NO in step S1401), the processing proceeds to step S1403. In step S1403, the web server function unit 605 determines whether download has been instructed by the user. In other words, the web server function unit 605 searches packets received via the connection unit 226 and determines whether a download request is included. If a download request is included, the web server function unit 605 determines that download has been instructed. In step S1403, if download is instructed (YES in step S1403), the processing proceeds to step S1404. In step S1404, the web server function unit 605 retrieves the setup program designated in the download request from the storage unit 601.

In step S1405, the web server function unit 605 transmits the setup program retrieved in step S1404 to the client 102 which has given a download instruction, and then the processing returns to step S1401. Further, in step S1403, if download is not instructed (NO in step S1403), the processing returns to step S1401.

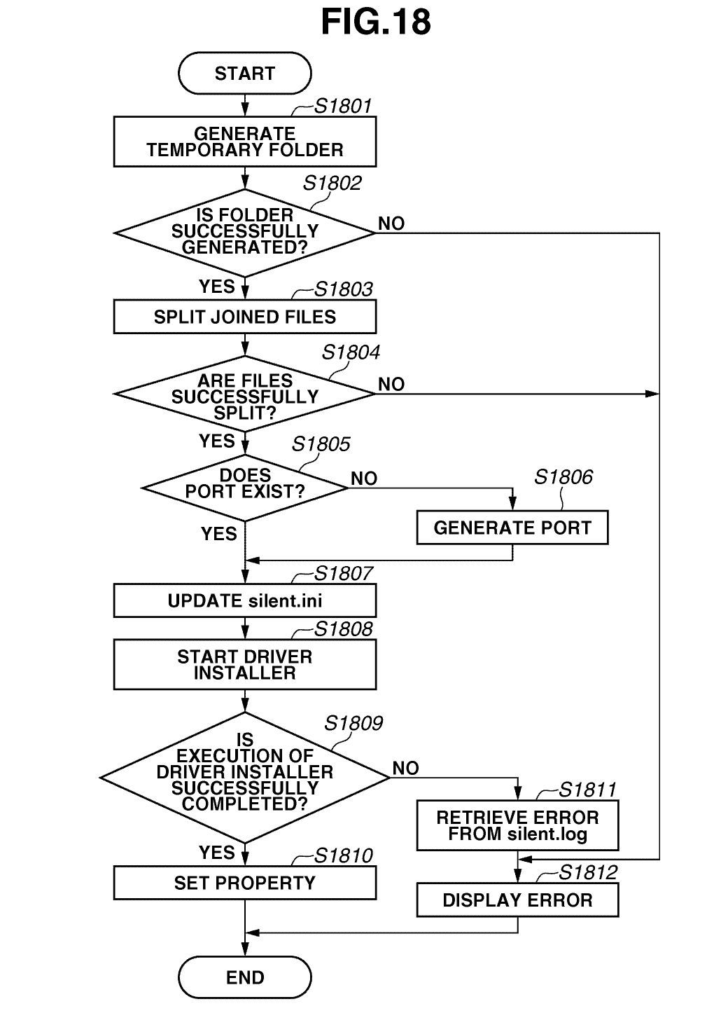

Next, the processing of the setup program 602 will be described with reference to FIG. 18. FIG. 18 is a flowchart illustrating an example of processing performed by the setup program 602. The processing performed by the setup program 602 is started when the program is downloaded to the client 102 and the user instructs the execution of the program. When the setup program 602 is started, it is loaded into a program area allocated in a storage unit of the client 102 such as the RAM 202 and executed by the CPU 200.

In step S1801, the setup program 602 generates a temporary folder. For example, by using a function provided by the OS, the setup program 602 generates a folder in a work area allocated in a storage area such as the RAM 202 or the HD 205.

In step S1802, the setup program 602 determines whether a folder has been successfully generated in step S1801. In step S1802, if a folder has been successfully generated (YES in step S1802), the processing proceeds to step S1803. In step S1803, the setup program 602 splits the joined files. In other words, the setup program 602 splits the files “silent.ini”, “setup.exe”, and “setup.ini” illustrated in FIG. 15B, and stores the split files in the temporary folder generated in step S1801.

In step S1804, the setup program 602 determines whether the files have been successfully split in step S1803. In step S1804, for example, if the file split processing has failed due to writing inhibition of the temporary folder (NO in step S1804), the processing proceeds to step S1812.

On the other hand, in step S1804, if the file split processing has been successfully performed (YES in step S1804), the processing proceeds to step S1805. In step S1805, the setup program 602 confirms whether a port is provided for the client 102. For example, a list of ports registered into the PC according to Win32 function Enum Port ( ) of Microsoft Windows (registered trademark) is acquired. If the acquired list of ports includes a port whose name is the same as the one described in the file “silent.ini” which has been split in step S1803, then the setup program 602 determines that a port exists.

In step S1805, if a port does not exist (NO in step S1805), the processing proceeds to step S1806. In step S1806, the setup program 602 generates a port having a port name described in the file “silent.ini”, which has been split and generated in step S1803, by a function provided in the OS. Then, the processing proceeds to step S1807.

On the other hand, in step S1805, if a port exists (YES in step S1805), the processing proceeds to step S1807. In step S1807, the setup program 602 updates the description of the file “silent.ini” split and generated in step S1803. For example, if restart of the PC is determined to be required after the install processing by a step (not shown), then the description of the [InstallComplete] section of the file “silent.ini” is changed to, for example, “Reboot=1”. Further, if the generation processing is not possible according to the port name or the printer name designated by the file “silent.ini”, then the description of PRT1 of the [PrinterInfo] section of the file “silent.ini” will be changed.

In step S1808, the setup program 602 starts the driver installer (“setup.exe”). In other words, the file “silent.ini” updated in step S1807 is transmitted to the driver installer (“setup.exe”), which has been split in step S1803, according to, for example, the following command, and then started. The command is, for example, “setup.exe/s silent.ini/log silent.log”.

The above-described command designates the file “silent.ini” as an information file and designates the file “silent.log” as a result storage file. The driver installer reads the instruction of the file “silent.ini”, performs a default operation regarding an item which is not described in the file “silent.ini”, and records the result in the file “silent.log”.

In step S1809, the setup program 602 determines whether the execution of the driver installer started in step S1808 has been completed. For example, if the return value of the driver installer is “0”, the setup program 602 determines that the execution of the driver installer has been completed. If the return value is a value other than “0”, the setup program 602 determines that the execution of the driver installer has failed. In step S1809, if the execution of the driver installer is completed (YES in step S1809), the processing proceeds to step S1810. In step S1810, the setup program 602 sets the property of the logical printer. For example, “Comments” described in the [PrinterInfo] section of the file “setup.ini” split in step S1803 is specified in a member “pComment” of “PRINTER_INFO_{—}2” structure according to Win32 function SetPrinter( ) of Microsoft Windows (registered trademark). Then, the setup program 602 terminates the program.

On the other hand, in step S1809, if the execution of the driver installer is not completed (NO in step S1809), the processing proceeds to step S1811. In step S1811, the setup program 602 retrieves error content from the file “silent.log” generated by the driver installer. In step S1812, the setup program 602 displays an error message corresponding to the error retrieved in step S1811 on the display unit 207 of the client 102, and then the processing ends.

Further, if the generation of a folder is not successfully performed in step S1802 (NO in step S1802) or if the generated files are not successfully split in step S1804 (NO in step S1804), the processing proceeds to step S1812. In step S1812, the setup program 602 displays a corresponding error message on the display unit 207 of the client 102, and then the processing ends.

According to the description above, the apparatus name and the IP address as the configuration information of the printing apparatus that changes are used as the printer name and the port name when the driver is installed in the information processing apparatus. However, the present invention is not limited to such an example. For example, in addition to the apparatus name and the IP address, the installation site information (the installation site 3016 in FIG. 3 or a comment (the comment 3017 in FIG. 3) which is set in the printing apparatus 105 can be acquired and reflected in the comment field of the logical printer when the driver is installed. Further, the present invention is also effective in a case where a host name of the printing apparatus 105 is set as the port name when the driver is installed.

Further, the present invention is also effective when an installer changes the operation mode of the printer driver installer by the PDL supported by the printing apparatus 105. For example, such an installer is an installer capable of installing three PDL printer drivers and changes the operation mode so that the printer driver corresponding to the PDL supported by the printing apparatus is installed.

Although a printer (printing apparatus) is taken as a representative example of the device, the device of the present invention is not limited to a printer. The present invention is also effective when a multifunction peripheral having a plurality of functions including at least the printer function is used. Further, the present invention is effective when a facsimile machine which operates with a facsimile driver having a configuration similar to that of a printer driver is used.

According to the above-described procedures, the administrator can simultaneously upload the printer driver into a plurality of printing apparatuses. Further, since the application of the printing apparatus examines the uploaded printer driver and determines whether the printer driver can deal with the printing apparatus, uploading a wrong printer driver can be prevented. Furthermore, since setting of an IP address is automatically performed by the application of the printing apparatus, a setting error can be prevented.

Further, since the changes in the setting (e.g., device name or IP address) of the printing apparatus can be automatically reflected in the uploaded printer driver, it helps reduce worry of the administrator. Further, when a printing apparatus is newly introduced, the announcement to the general user asking for installation of the printer driver can be easily accomplished by notifying the user of a download page of the printing apparatus. Furthermore, a dedicated server is unnecessary according to the present invention.

Further, the general user can install a printer driver (with desired PDL or version, or customized printer driver) of a desired printing apparatus in a PC (information processing apparatus) without difficult operations. Furthermore, since various settings associated with the printer driver installation and the setting of ports can be automatically performed, the number of operations performed by the user can be reduced, which contributes to reducing errors. Further, by referring to the download page, the general user can easily determine a printer driver according to the comment input by the administrator. Since the preparation for the printing apparatus before it is used can be easily completed, the number of inquiries to the administrator can be reduced. As described above, the work of the administrator is reduced at the time a printer is introduced or a printer driver is updated and convenience of the general user is improved. In other words, the present invention affords improved convenience to both the administrator and the general user.

The configuration and content of data according to an exemplary embodiment of the present invention are not limited to the various types of data described above, and can be configured to have various configurations and contents according to the application. Further, although an exemplary embodiment is illustrated in the description above, the present invention can take various embodiments concerning, for example, a system, an apparatus, a method, a program, or a storage medium. In other words, the present invention can be applied to a system including a plurality of apparatuses or to an apparatus configured from one apparatus.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-006742 filed Jan. 15, 2010, which is hereby incorporated by reference herein in its entirety.

What is claimed is:

1. A printing apparatus comprising:
a storage unit configured to store a plurality of setup programs for respective printer drivers registered by a management apparatus;
an update unit configured to set configuration information of the printing apparatus for installing the printer drivers with respect to the stored setup programs and to update the setup programs; and
a provision unit configured to transmit information of the stored setup programs to an information processing apparatus according to a request from the information processing apparatus and to provide a setup program selected by the information processing apparatus to the information processing apparatus.

2. The printing apparatus according to claim 1, further comprising a monitor unit configured to monitor whether a new setup program has been stored in the storage unit,
wherein, if the new setup program has been stored in the storage unit, the update unit sets the configuration information with respect to the stored setup program.

3. The printing apparatus according to claim 2, wherein the monitor unit monitors whether the configuration information has changed, and if the configuration information has changed, the update unit sets the configuration information with respect to the stored setup program.

4. The printing apparatus according to claim 1, wherein the configuration information of the printing apparatus includes a host name or an IP address of the printing apparatus.

5. The printing apparatus according to claim 4, wherein the configuration information further includes at least one of an apparatus name of the printing apparatus and a comment used for inputting an installation site of the printing apparatus.

6. A system including a printing apparatus and a management apparatus,
wherein the management apparatus comprises:
a setting input unit configured to receive setting information used for installing a printer driver corresponding to the printing apparatus;
a generation unit configured to generate a setup program associated with the printer driver corresponding to the printing apparatus and the received setting information; and
a registration unit configured to register the generated setup program in the corresponding printing apparatus, and
wherein the printing apparatus comprises:
a storage unit configured to store a plurality of setup programs registered by the management apparatus;
an update unit configured to set configuration information of the printing apparatus with respect to the stored setup programs and to update the setup programs; and
a provision unit configured to transmit information of the stored setup programs to an information processing apparatus according to a request from the information processing apparatus and to provide a setup program selected by the information processing apparatus to the information processing apparatus.

7. The system according to claim 6, wherein the printing apparatus further comprises a monitor unit configured to monitor whether a new setup program has been stored in the storage unit,
wherein, if the new setup program has been stored in the storage unit, the update unit sets the configuration information with respect to the stored setup program.

8. The system according to claim 7, wherein the monitor unit monitors whether the configuration information has changed, and if the configuration information has changed, the update unit sets the configuration information with respect to the stored setup program.

9. The system according to claim 6, wherein the configuration information includes a host name or an IP address of the printing apparatus.

10. A method for controlling a printing apparatus including a storage unit, the method comprising:
storing a plurality of setup programs for respective printer drivers registered by a management apparatus in the storage unit;
setting configuration information of the printing apparatus for installing the printer drivers with respect to the stored setup programs and updating the setup programs; and
transmitting information of the stored setup programs to an information processing apparatus according to a request from the information processing apparatus and providing a setup program selected by the information processing apparatus to the information processing apparatus.

11. The method according to claim 10, further comprising monitoring whether a new setup program has been stored in the storage unit,
wherein, if the new setup program has been stored in the storage unit, setting the configuration information with respect to the stored setup program.

12. The method according to claim 11, wherein the monitoring monitors whether the configuration information has changed, and if the configuration information has changed, setting the configuration information with respect to the stored setup program.

13. The method according to claim 10, wherein the configuration information includes a host name or an IP address of the printing apparatus.

14. A method for controlling a system including a printing apparatus including a storage unit and a management apparatus, the method comprising:
with respect to the management apparatus,
receiving setting information used for installing a printer driver corresponding to the printing apparatus;
generating a setup program associated with the printer driver corresponding to the printing apparatus and the received setting information; and
registering the generated setup program in the corresponding printing apparatus, and
with respect to the printing apparatus,
storing a plurality of setup programs registered by the management apparatus in the storage unit;
setting configuration information of the printing apparatus with respect to the stored setup programs and updating the setup programs; and
transmitting information of the stored setup programs to an information processing apparatus according to a request from the information processing apparatus and providing a setup program selected by the information processing apparatus to the information processing apparatus.

15. The method according to claim 14, with respect to the printing apparatus, further comprising monitoring whether a new setup program has been stored in the storage unit,
wherein, if the new setup program has been stored in the storage unit, setting the configuration information with respect to the stored setup program.

16. The method according to claim 15, wherein the monitoring monitors whether the configuration information has changed, and if the configuration information has changed, setting the configuration information with respect to the stored setup program.

17. The method according to claim 14, wherein the configuration information includes a host name or an IP address of the printing apparatus.

18. A computer-readable storage medium storing a computer program that causes a computer to execute a method for a printing apparatus, the method comprising:
storing a plurality of setup programs for respective printer drivers registered by a management apparatus in a storage unit;
setting configuration information of the printing apparatus for installing the printer drivers with respect to the stored setup programs and updating the setup programs; and
transmitting information of the stored setup programs to an information processing apparatus according to a request from the information processing apparatus and providing a setup program selected by the information processing apparatus to the information processing apparatus.

19. The computer-readable storage medium according to claim 18, further comprising monitoring whether a new setup program has been stored in the storage unit,
wherein, if the new setup program has been stored in the storage unit, setting the configuration information with respect to the stored setup program.

20. The computer-readable storage medium according to claim 19, wherein the monitoring monitors whether the configuration information has changed, and if the configuration information has changed, setting the configuration information with respect to the stored setup program.

21. The computer-readable storage medium according to claim 18, wherein the configuration information includes a host name or an IP address of the printing apparatus.
